(19) United States
(12) Patent Application Publication
(10) Pub. No.: US 2009/0289909 A1
(43) Pub. Date: Nov. 26, 2009

(54) DISPLAY DEVICE WITH TOUCH CONTROL FUNCTION

(75) Inventor: Bo-Hua LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/394,226

(22) Filed: Feb. 27, 2009

(30) Foreign Application Priority Data
May 21, 2008 (CN) 200810301705.1

(51) Int. Cl. G06F 3/046

(52) U.S. Cl. 345/173

(57) ABSTRACT

A display device (10) with touch control function includes a display panel (12), a backlight module (13), a circuit board (14), a processing module (15) and a frame (16). The backlight module supplies light to the display panel. The display panel, the backlight module, the circuit board and the processing module are contained in the frame. A plurality of magnetically sensitive elements (142) are mounted on the circuit board. The processing module electronically connects with the display panel, the backlight module and the circuit board. The processing module receives signals from the magnetically sensitive elements, and sends control data to the display panel and the backlight module.

### BACKGROUND

1. Technical Field

The present invention relates to display devices, particularly, to a display device with touch control function.

2. Description of Related Art

Display devices with touch control functions are widely applied to portable electronic devices, such as mobile phones, personal digital assistants, notebooks and etc. A typical display device with touch control function includes a touch panel, a display panel, a back light module and a processing module. The touch panel, the display panel and the back light module are electronically connected to the processing module. The touch panel is positioned on the display panel. An operating signal is produced when a finger or stylus touches the touch panel, and the signal is transmitted to the processing module. The processing module processes the operating signal and sends data to the display panel and the back light module to operate. However, the touch panel is usually thin, and is directly touched by finger or stylus. Thus the touch panel may easily be scraped after repeatedly usage. Therefore, there is space for improvement within the art.

### BRIEF DESCRIPTION OF THE DRAWINGS

Many aspects of the display device with touch control function can be better understood with reference to the following drawings. The components in the drawings are not necessarily drawn to scale, the emphasis instead being placed upon clearly illustrating the principles of the present display device, in which:

FIG. 1 is an exploded, schematic view of a display device with touch control function, in accordance with an exemplary embodiment;

FIG. 2 is an assembled, cross-sectional, schematic view of the display device shown in FIG. 1;

FIG. 3 is a flow chart of the display device shown in FIG. 1; and

FIG. 4 is an assembled, schematic view of the display device shown in FIG. 1, incorporating a stylus.

### DETAILED DESCRIPTION OF THE EMBODIMENTS

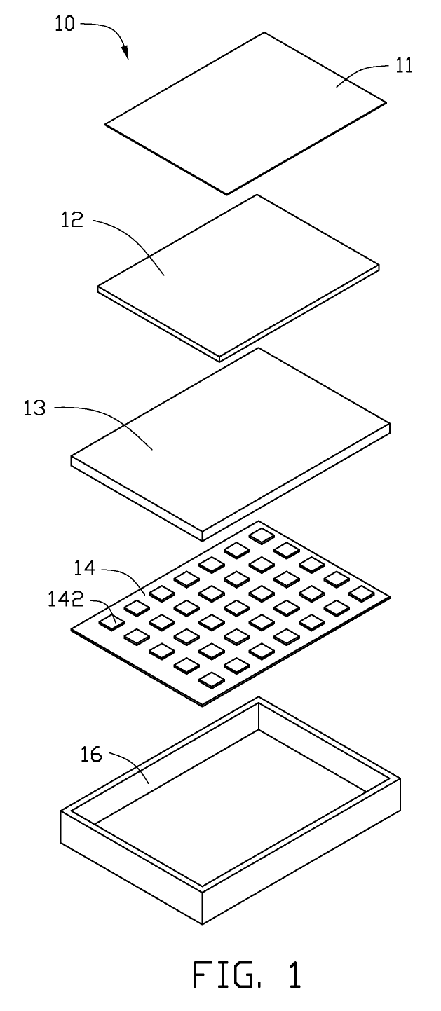

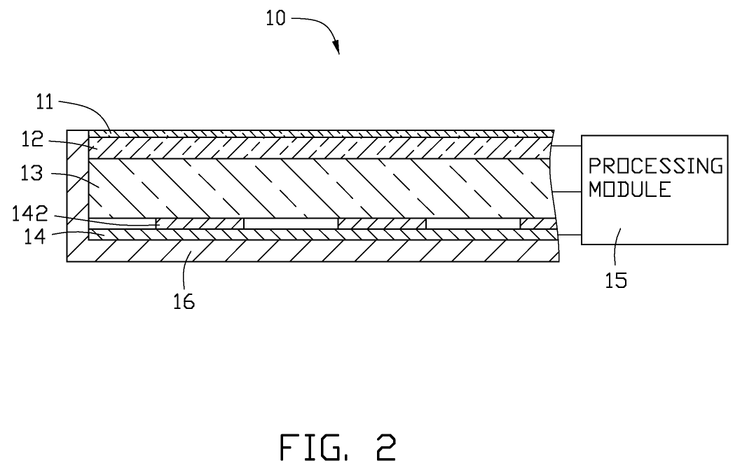

Referring to FIGS. 1 and 2, a display device in accordance with an exemplary embodiment 10 includes a protective film 11, a display panel 12, a backlight module 13, a circuit board 14, a processing module 15 and a frame 16. The circuit board 14, the back light module 13, the display panel 12, and the protective film 11 are fixed in the frame 16 in the order written, and electronically connected to the processing module 15.

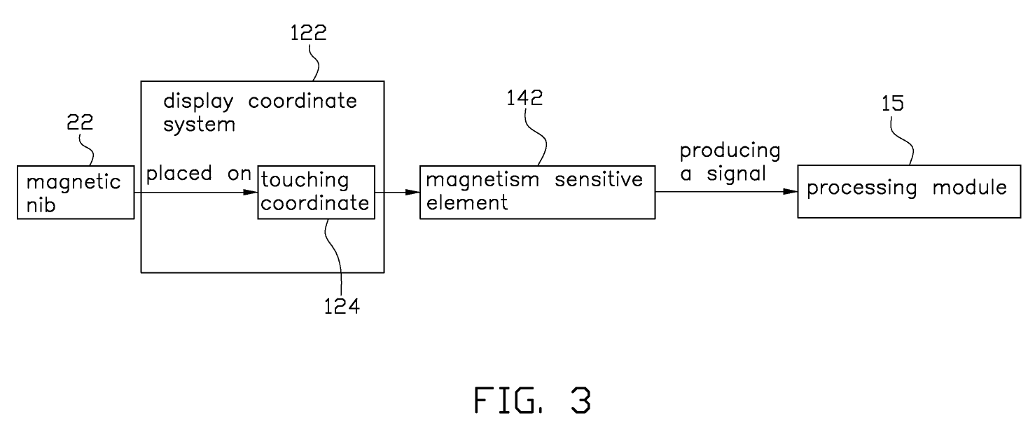

The protective film 11 attached to the display panel 12 may be a transparent resin film, configured for protecting the display panel 12 from being scratched. Also referring to FIG. 3, the display panel 12 is a liquid crystal display panel 12, and has a display coordinate system 122 set therein. The display coordinate system 122 includes a plurality of touching coordinates 124. The backlight module 13 is positioned between the display panel 12 and the circuit board 14, configured for supplying light to the display panel 12. A plurality of magnetically sensitive elements 142 are positioned on the circuit board 14 in an array, forming a magnetically sensitive plane. The magnetically sensitive elements 142 respectively correspond to the touching coordinates 124 of the display panel 12. The processing module 15 stores data corresponding to the touching coordinate 124, and is used to process the signal from the circuit board 14, and sends control data to the display panel 12 and the backlight module 13.

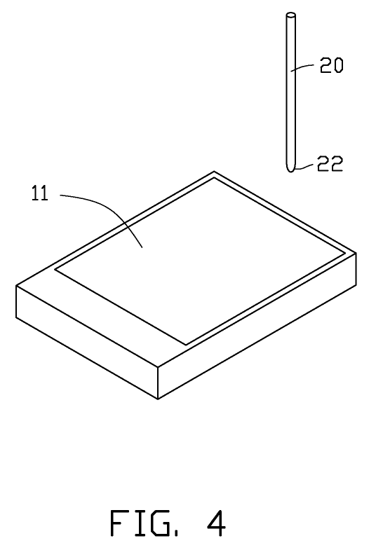

Referring to FIG. 4, a stylus 20, cooperating with the display device 10, includes a magnetic nib 22. When the magnetic nib 22 touches the protective film 11, the magnetically sensitive elements 142 on the circuit board 14 can sense the magnetically of the magnetic nib 22. When the magnetic nib 22 is placed on a touching coordinate 124, the corresponding magnetically sensitive element 142 senses the magnetically of the magnetic nib 22, and produces a signal, which is transmitted to the processing module 15. The processing module 15 receives the signal, and calculates the coordinate of the magnetic nib 22. The processing module 15 sends a signal to the display panel 12 according to the coordinate of the magnetic nib 22. The display panel 12 receives the signal and shows a corresponding data, so as to provide feed back for the operation. Also, the processing module 15 sends a light signal to the backlight module 13 at a same time. The backlight module 13 receives the light signal, and adjusting strength and color of the light.

It is to be understood that the present display device 10 does not have conventional touch panel, so as to be more durable than the typical display device with touch control function. In addition, the present display device 10 applies magnetically sensitive elements 142 cooperating with the magnetic nib 22. If something non-magnetic accidentally touches the protective film 11, no feedback will be produced. This may reduce mistakes in operation.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A display device with touch control function comprising:
a display panel;
a backlight module supplying light to the display panel;
a circuit board having a plurality of magnetically sensitive elements mounted there on;
a processing module electronically connecting with the display panel, the backlight module and the circuit board, the processing module receiving signals from the magnetically sensitive elements and sends control data to the display panel and the backlight module; and
a frame; the display panel, the backlight module, the circuit board and the processing module being contained in the frame.

2. The display device as claimed in claim 1, further comprising a protective film placed on the display panel.

3. The display device as claimed in claim 2, wherein the protective film is made of transparent resin material.

4. The display device as claimed in claim 1, wherein the display panel is a liquid crystal display panel.

5. The display device as claimed in claim 1, wherein a display coordinate system is set in the display panel.

6. The display device as claimed in claim 5, wherein the display coordinate system includes a plurality of touching coordinates, and the magnetically sensitive elements respectively correspond to the touching coordinates.

7. The display device as claimed in claim 1, wherein the magnetically sensitive elements are positioned in array.

8. The display device as claimed in claim 6, further comprising a stylus, wherein the stylus includes a magnetic nib, and the magnetically sensitive element produces a signal when the magnetic nib is positioned at one of the touching coordinates.

9. A display device with touch control function comprising:
a display panel having a display coordinate system set therein, the display coordinate system having a plurality of touching coordinates;
a backlight module supplying light to the display panel;
a plurality of magnetically sensitive elements respectively corresponding to the touching coordinates; and
a processing module electronically connecting the display panel, the backlight module and the magnetically sensitive elements, the processing module receiving signals from the magnetically sensitive elements and sending control data to the display panel and the backlight module.

10. The display device as claimed in claim 9, further comprising a protective film placed on the display panel.

11. The display device as claimed in claim 10, further comprising a stylus, wherein the stylus includes a magnetic nib, and the magnetically sensitive element produces a signal when the magnetic nib is positioned at one of the touching coordinates.
